(19) United States
(12) Patent Application Publication
(10) Pub. No.: US 2025/0187682 A1
(43) Pub. Date: Jun. 12, 2025

(54) TRACK SYSTEM AND ENDLESS TRACK

(71) Applicant: SOUCY INTERNATIONAL INC., Drummondville (CA)

(72) Inventors: Yves SAUVAGEAU, Drummondville (CA); William BRISSON, Saint-Cyrille-De-Wendover (CA); Pierre-Yves PEPIN, Drummondville (CA); Branislav NANAC, Drummondville (CA)

(21) Appl. No.: 18/846,108

(22) PCT Filed: Apr. 6, 2023
(86) PCT No.: PCT/CA2023/050482

§ 371 Date: Sep. 11, 2024

Related U.S. Application Data
(60) Provisional application No. 63/328,650, filed on Apr. 7, 2022.

(51) Int. Cl. B62D 55/084; B62D 55/065; B62D 55/10; B62D 55/125; B62D 55/14; B62D 55/24

(52) U.S. Cl. CPC B62D 55/084; B62D 55/10; B62D 55/125; B62D 55/14; B62D 55/244; B62D 55/065

(57) ABSTRACT

A track system, which is for a vehicle, includes a drive wheel assembly, a frame assembly, an undercarriage assembly and an endless track. The drive wheel assembly is operatively connectable to a shaft of the vehicle, and is rotatable about a first pivot axis. The frame assembly includes a first frame member that is removably connected to the vehicle, and a second frame member pivotally connected to the first frame member about a second pivot axis that is vertically spaced from the first pivot axis. The undercarriage assembly includes a beam with a connecting pin, at least one resilient bushing and at least one support wheel assembly. The endless track is drivingly engaged to the drive wheel assembly. An endless track is also disclosed.

### CROSS-REFERENCE TO RELATED APPLICATION

The present application claims priority to U.S. Provisional Patent Application No. 63/328,650, filed Apr. 7, 2022 entitled “Rear Track System and Vehicle Having the Same”, which is incorporated by reference herein in its entirety.

### TECHNICAL FIELD

The present application generally relates to track systems and endless tracks.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. Some conventional track systems may not be connectable do various types of vehicles because of the clearance required to install said track systems. Additionally, some conventional track systems can be difficult to adjust for various desired properties, such as, for example, increased steerability in some instances instead of having increased floatability.

Additionally, conventional track systems come equipped with conventional endless tracks that can be prone to cracking and premature wear and can have difficulty sustaining high loads applied thereto by a drive wheel assembly.

Therefore, there is a desire for a track system that could mitigate the above-

### SUMMARY

It is an object of the present technology to ameliorate at least some of the inconveniences present in the prior art.

According to an aspect of the present technology, there is provided a track system for a vehicle, the track system including a drive wheel assembly, a frame assembly, and an undercarriage assembly. The drive wheel assembly is operatively connectable to a shaft of the vehicle and is rotatable about a first pivot axis. The frame assembly includes a first frame member configured to removably connect to the vehicle, and a second frame member pivotally connected to the first frame member about a second pivot axis that is vertically spaced from the first pivot axis. The undercarriage assembly includes a beam having a connecting pin, at least one resilient bushing having a first surface fixedly connected to the connecting pin, and a second surface fixedly connected to the second frame member, and at least one support wheel assembly connected to the beam. The endless track drivingly engaged to the drive wheel assembly.

In some embodiments, the first frame member is configured to connect to an axle housing of the vehicle.

In some embodiments, the second frame member is at least partially below the first frame member.

In some embodiments, the frame assembly is disposed at least partially laterally inwardly from the drive wheel.

In some embodiments, the first frame member is configured to connect to the vehicle in a plurality of positions.

In some embodiments, a first position of the plurality of positions is angularly offset from a second position of the plurality of position.

In some embodiments, when the first frame member is in the first position, the second pivot axis is in a first axis position, when the first frame member is in the second position, the second pivot axis is in a second axis position, and the first axis position is offset from the second axis position in at least one of: a longitudinal direction and a vertical direction.

In some embodiments, the first frame member has a first portion disposed on a first longitudinal side of the drive wheel assembly, a second portion disposed on a second longitudinal side of the drive wheel assembly, and the first and second portions of the first frame member at least partially surround the drive wheel assembly.

In some embodiments, the frame assembly further includes a pivot assembly having a pin defining the pivot axis, and the second frame member is pivotally connected about the second pivot axis to the first frame member by the pivot assembly.

In some embodiments, the first frame member has stoppers to limit pivotal moment of the first and second frame members.

According to another aspect of the present technology, there is provided an endless track for a track system. The endless track includes a track body and a plurality of traction lugs. The track body has an inner surface engageable by at least one wheel assembly of the track system, and an outer surface engageable to a ground surface. The plurality of traction lugs project from the outer surface and are spaced along a length of the track body. A given traction lug of the plurality of traction lugs has an inner portion and an outer portion. The inner and outer portions extend along a length of the given traction lug, and the outer portion is closer to an edge of the track body than the inner portion. The inner portion has an inner volume, and the outer portion has an outer volume, the outer volume being greater than the inner volume.

In some embodiments, the inner portion defines a recess.

In some embodiments, a given traction lug of the plurality of traction lugs has a first cross-sectional area taken across a plane perpendicular to the inner portion, a second cross-sectional area taken across a plane perpendicular to the outer portion, and the first cross-sectional area is less than the second cross-sectional area.

In some embodiments, the inner portion defines an aggressive angle.

In some embodiments, the given traction lug has a large radius.

In some embodiments, the outer portion extends from an inner side of a wheel path of the track body to the edge of the track body.

In some embodiments, the given traction lug at least substantially perpendicular to a longitudinal plane of the track body.

In some embodiments, the outer portion of the given traction lug is at least partially perpendicular to the longitudinal plane of the track body.

In some embodiments, the given traction lug is partially arcuate.

According to another aspect of the present technology, there is provided a track system for a vehicle. The track system includes a multi-member frame assembly, a leasing idler wheel assembly, a trailing idler wheel assembly, a suspended undercarriage assembly and an endless track. The multi-member frame assembly includes a primary frame member defining a mounting portion, and a secondary frame member below the primary frame member and pivotable relative to the primary frame about a pivot axis. The drive wheel is operatively connected to an axle of the vehicle. The leading idler wheel assembly is at least indirectly connected to the multi-member frame assembly. The trailing idler wheel assembly is at least indirectly connected to the multi-member frame assembly. The suspended undercarriage assembly is resiliently connectable to the secondary frame member. The endless track is wrapped around the multi-member frame assembly, the leading and trailing idler wheel assemblies, and the suspended undercarriage assembly, The mounting portion is removably connectable to a fixed structure of the vehicle.

In some embodiments, the fixed structure is an axle housing.

In some embodiments, the multi-member frame assembly is behind the drive wheel.

In some embodiments, the multi-member frame assembly surrounds at least a portion of the drive wheel.

In some embodiments, the frame further comprises a pivot assembly connectable to one of the primary frame member and the secondary frame member.

In some embodiments, the pivot assembly includes a pivot pin extending laterally and defining the pivot axis located below an axis of rotation of the drive wheel.

In some embodiments, the mounting portion of the primary frame member is configured to be installed in different orientations about an axis of rotation of the drive wheel such that the pivot axis is moved longitudinally and vertically.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a vehicle having track systems according to embodiments of the present technology;

FIG. 2 is an exploded perspective view taken from a top, front, left side of a rear left track system of the vehicle of FIG. 1;

FIG. 3 is a perspective view taken from a bottom, front, right side of part of the track system of FIG. 2, with an endless track thereof being omitted;

FIG. 4 is a perspective view taken from a top, front, left side of an undercarriage assembly of the track system of 2;

FIG. 5 is a perspective view taken from a top, front, left side of an alternative embodiment of the track system of FIG. 2;

FIG. 6 is a perspective view taken from a top, front, left side of the track system of FIG. 5 connected to an axle housing, with a drive wheel assembly and an endless track being omitted;

FIG. 7A is a schematic view of a frame assembly of the track system of FIG. 5 being connected to the axle housing in a first configuration;

FIG. 7B is a schematic view of a frame assembly of the track system of FIG. 5 being connected to the axle housing in a second configuration;

FIG. 8 is a perspective view taken from a top, front, left side of a segment of an endless track of the track system of FIG. 1;

FIG. 9 is a side elevation view of another segment of the endless track of FIG. 8;

FIG. 10 is a top plan view of the segment of the endless track of FIG. 8; and

FIG. 11 is a front elevation view of the segment of the endless track of FIG. 8.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

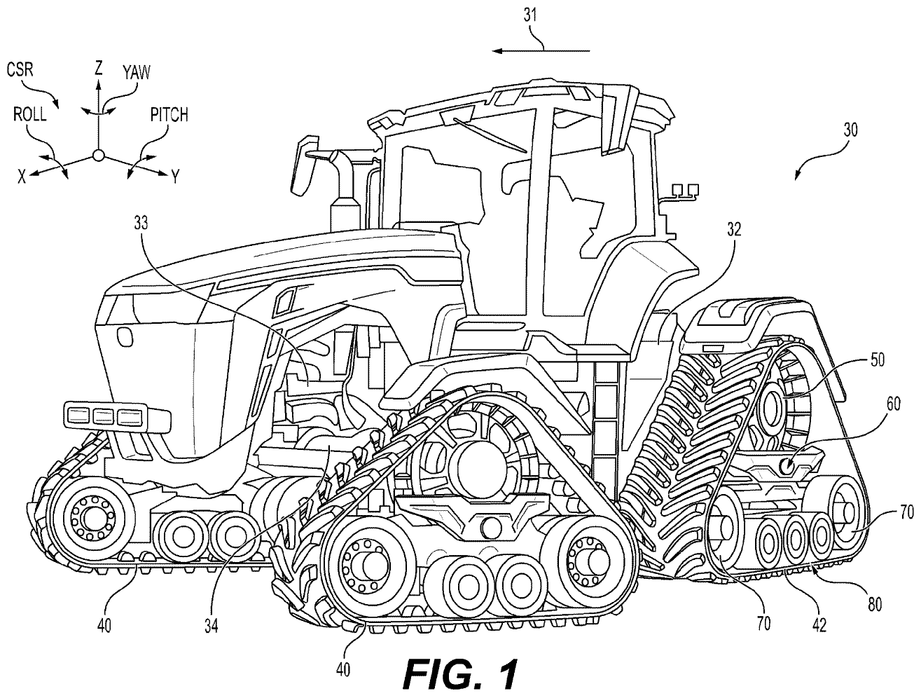

With reference to FIG. 1, a vehicle 30, of which the forward direction is indicated by arrow 31, is shown with track systems according to embodiments of the present technology: two front track systems 40, and two rear track systems 42 (only rear left track system 42 is shown). In some embodiments, the vehicle 30 could have more or fewer than four track systems. The vehicle 30 has a chassis 32 that supports various components thereof. The vehicle 30 also includes a motor 33 supported by the chassis 32. The vehicle also has a leading and trailing driving axles 34 (only front driving axle 34 shown in FIG. 1) that are operatively connected to the motor 33. As will be described in greater detail below, the driving axles 34 are operatively connected with the track systems 40, 42. In the illustrated embodiments, the vehicle 30 is an agricultural vehicle. It is contemplated that in other embodiments, the vehicle to which the track systems 40, 42 are connected could be different. For example, in some embodiments, the vehicle 30 could be an all-terrain vehicle or a snowmobile.

In some embodiments, the vehicle 30 may originally have been designed and manufactured as a tracked vehicle with at least some of the track systems 40, 42 already provided thereon.

In other embodiments, the vehicle 30 may originally have been designed and manufactured as a wheeled vehicle. The track systems 40, 42 may have been added subsequently to enhance traction and floatation of the vehicle 30 on the ground.

### General Description

Referring to FIGS. 1 to 3, the track systems 40, 42 will now be broadly described. As the track systems 40, 42 are similar to one another, only one of the rear track systems 42 will be described herewith. The track system 42 includes a drive wheel assembly 50, a frame assembly 60, idler wheel assemblies 70, support wheel assemblies 80, and an endless track 90.

The track system 42 has a longitudinal center plane that extends along a longitudinal direction thereof, and that passes through a lateral central point thereof. Thus, a height of the track system 42 is perpendicular to the longitudinal and lateral directions of the track system 42. Therefore, when the vehicle 30 is on a horizontal ground surface, the height direction of the track system 42 corresponds to a vertical direction. The track system 42 has a length L, a width W, and a height H.

### Drive Wheel Assembly

The drive wheel assembly 50 is operatively connected to the driving axle 34 of the vehicle 30, and is drivingly engaged with the endless track 90. The drive wheel assembly 50 rotates about the a driving axis 52, which is generally aligned with the driving axle 34. In some embodiments, the drive wheel assembly 50 is connected to driving axle 34 by a hub assembly. The driving axis 52 is disposed longitudinally between the front and rear idler wheel assemblies 70. When the driving axle 34 rotates, due to the motor 33 of the vehicle 30, the drive wheel assembly 50 also rotates. Then, due to the driving engagement between the drive wheel assembly 50 and the endless track 90, the drive wheel assembly 50 imparts motion to the endless track 180, which can thus propel the vehicle 30 on the ground.

In the illustrated embodiment, the drive wheel assembly 50 defines a plurality of recesses 54 on a periphery thereof. The recesses 54 are configured to receive driving lugs 96 disposed on an inner surface 92 of the endless track 90. In other embodiments, the drive wheel assembly 50 could have engaging members that extend radially and that engage with the driving lugs 96. As another example, in some embodiments, the drive wheel assembly 50 may frictionally engage the inner side 92 of the endless track 90 in order to frictionally drive the endless track 90.

### Frame Assembly

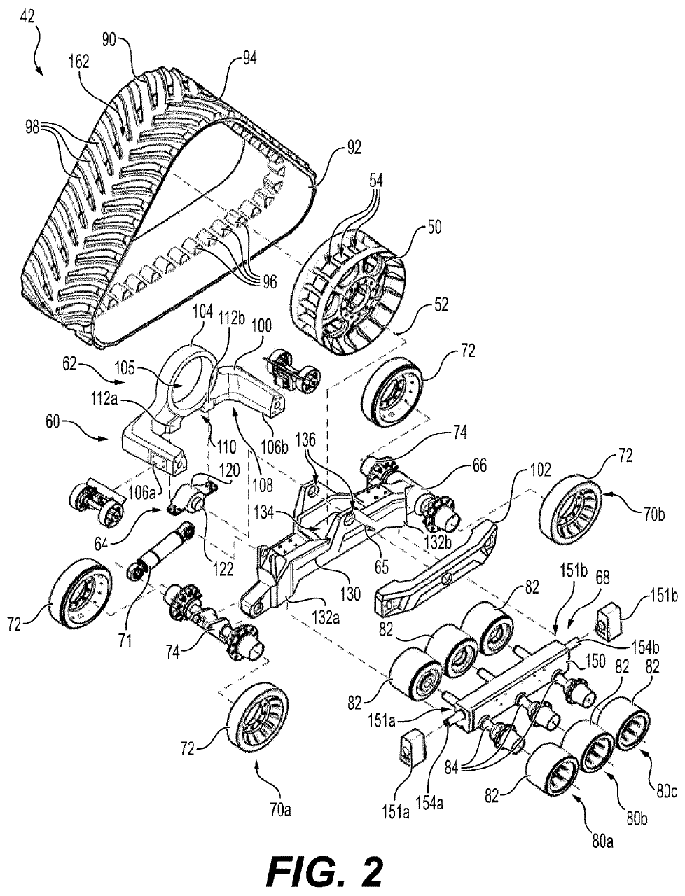

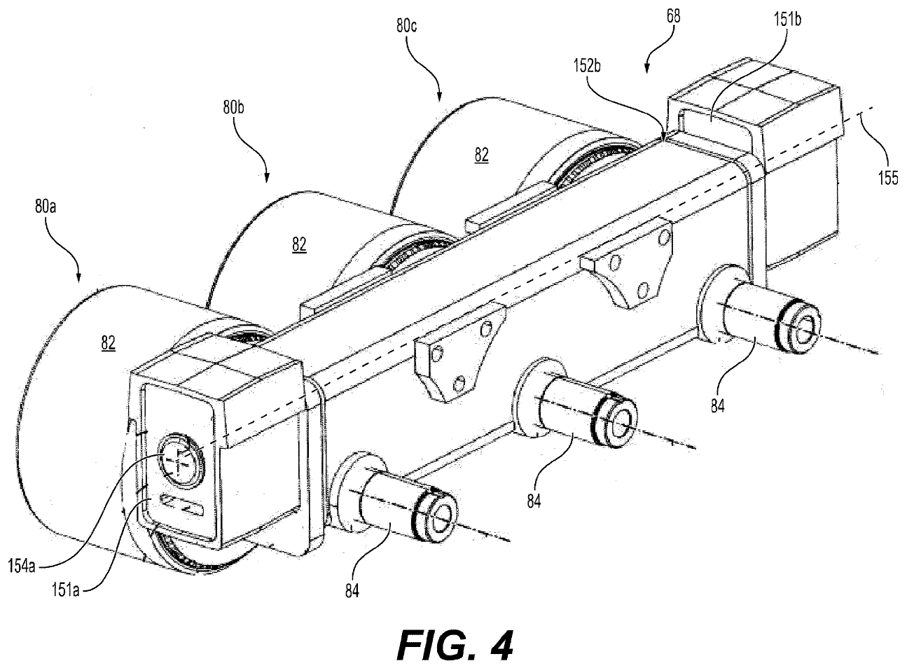

With continued reference to FIGS. 2 to 4, the frame assembly 60, which is disposed at least partially laterally inwardly from the drive wheel assembly 50, will be briefly described. The frame assembly 60 is a multi-member assembly that includes an upper frame member 62, a pivot assembly 64 and a lower frame member 66. It is contemplated that the frame assembly 60 could have more or fewer members in other embodiments. The pivot assembly 64 enables the lower frame member 66 to pivot relative to the upper frame member 62. More precisely, the lower frame member 66 is pivotable relative to the upper frame member 62 about a pivot axis 65. The frame assembly 60 will be described in greater detail below.

The track assembly 42 also includes the undercarriage assembly 68, which is pivotally connected to the lower frame member 66. The undercarriage assembly 68, which supports the support wheel assemblies 80, will also be described in greater detail below.

Part of the weight of the vehicle 30 is sustained by the track system 42. The load sustained by the track system 42 is transferred to mounting portion 104, then to the pivot assembly 64, then to the lower frame member 96, to the idler and support wheel assemblies 70, 80. It is to be noted that the drive wheel assembly 50 does not bear a material load sustained by the track system 42. Other configurations are contemplated as well.

### Idler Wheel Assembly

As mentioned above, the track system 42 includes the idler wheel assemblies 70 that are rotationally connected to the frame assembly 70. Specifically, the track system 42 includes a front idler wheel assembly 70a that is connected to a front end of the lower frame member 66 and a rear idler wheel assembly 70b that is connected to a rear end of the lower frame member 66. In the illustrated embodiment, the front idler wheel assembly 70a is also connected to a tensioner 71, which is operable to adjust a tension in the endless track 90. It is contemplated that the front and rear idler wheel assemblies 70a, 70b are connected to another part of the track system 42.

Each one of the front and rear idler wheel assemblies 70a, 70b have two laterally spaced wheels 72 that are connected to one another by a shaft 74. The lateral spacing between the wheels 72 is for, in part, accommodating for the driving lugs 96 therebetween, and thus assist in guiding the endless track 90 by preventing undesired lateral movement. In this embodiment, each of the laterally spaced wheels 72 includes a wheel body made of rigid material (e.g., steel or other metal) and a peripheral portion made of elastomeric material (e.g., rubber) that enhances its grip on the inner side 92 of the endless track 90. It is contemplated that the construction of wheels 72 may vary from one embodiment to another. The shaft 74 is connected to the lower frame member 66. In some embodiments, the shaft 74 is removably connected to the lower frame member 66. In other embodiments, the shaft 74 is non-removably connected to the lower frame member 66.

The front and rear idler wheel assemblies 70a, 70b are used for, inter alia, supporting a portion of the weight of the vehicle 30, guiding the endless track 90, and/or tensioning the endless track 90.

### Support Wheel Assembly

The support wheel assemblies 80 are connected to the frame assembly 60. In the illustrated embodiment, the support wheel assemblies 80 are connected to the undercarriage assembly 68, which is in turn, as mentioned above, connected to the lower frame member 66. There are three support wheel assemblies 80a, 80b, 80c, each of which has two laterally spaced wheels 82 and a shaft 84. The shaft 84 is connected to the undercarriage assembly 68. In some embodiments, the shaft 84 is integral with the undercarriage assembly 68. The support wheel assemblies 80, which roll on a lower run of the endless track 90, distribute a weight borne thereby on the endless track 90, and guide the endless track 90. In some instances, since the support wheel assemblies 80 are disposed longitudinally between the front and rear idler wheel assemblies 70a, 70b, the support wheel assemblies can be referred to as “mid-roller assemblies”. In this embodiment, each of the support wheel assemblies 80 includes a wheel body made of rigid material (e.g., steel or other metal) and a peripheral portion made of elastomeric material (e.g., rubber) that enhances its grip on the inner side of the endless track 90. The support wheel assemblies 80 may be constructed in various other manners and/or using various other materials in other embodiments.

### Endless Track

The endless track 90 engages the ground to provide traction to the vehicle 30. The endless track 90 has an inner side 92 and a ground-engaging outer side 94. The inner side 92, which is configured to engage the drive, idler and support wheel assemblies 40, 70, 80, has driving lugs 96 extending therefrom. The driving lugs 96 are longitudinally spaced from one another, and are generally disposed centrally across a width of the endless track 90. The outer side 94, which is configured to engage the ground surface, has traction lugs 98 extending therefrom. The endless track 90 will be described in greater detail below.

### Frame Assembly

Still referring to FIGS. 2 to 4, the frame assembly 60 will now be described in greater detail.

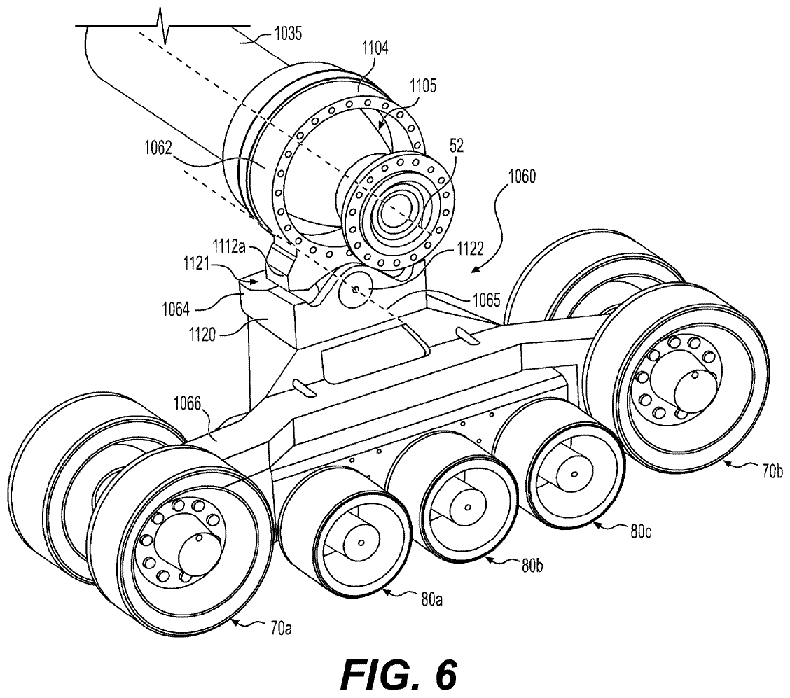

The frame assembly 60 includes the upper frame member 62 that is connectable to an axle housing of the driving axle 34 (axle housing is shown in FIG. 6, which depicts an alternate embodiment of the track system 42) and a lower frame member 62 that is configured to receive leading and trailing portions of the suspended undercarriage assembly 68. The pivot assembly 64 is disposed between the upper and lower frame members 62, 66 and enables a pivotal connection therebetween about the pivot axis 65, which extends generally laterally (i.e., generally perpendicular to a longitudinal plane of the vehicle 30).

The upper frame member 62 is configured to connect to the axle housing of the driving axle 64, as will be described below, in a plurality of positions, each position being angularly spaced from an other one of the plurality of positions.

The upper frame member 62 is made of two parts connected to one another: inner part 100 and outer part 102, the outer part 102 being laterally outwardly from the inner part 100 relative to the vehicle 30. It is contemplated that in some embodiments, the upper frame member 62 could be made of a single part. It is also contemplated that the upper frame member 62 could be made of three or more parts connected to one another. Additionally, the inner and outer parts 100, 102 could be removably or non-removably connected to one another. The upper frame member 62 can be made of rigid material, such as aluminum, or steel.

The inner part 100 generally forms, as seen from above, a U-shape. The inner part 100 has a mounting portion 104, a front portion 106a extending forward from the mounting portion 104, and a rear portion 106b extending rearward from the mounting portion 104. The front portion 106a, the mounting portion 104 and the rear portion 106b define a cavity 108 that is configured to partially receive the drive wheel assembly 50 therein. In some embodiments, the front and rear portions 106a, 106b are separate components that are connected together. The inner part 100 also defines a lower recess 110 at a bottom of the mounting portion 104. In other instances, the lower recess 110 could be defined elsewhere. The lower recess 110 is configured to partially receive the pivot assembly 64 therein. On either side longitudinal side of the lower recess 110, the inner part 100 also has a front stopper 112a and a rear stopper 112b. As will be described in greater detail below, the front and rear stoppers 112a, 112b can assist in limiting the pivotal movement of the lower frame member 66 relative to the upper frame member 62. In some embodiments, the front and rear stoppers 112a, 112b could be omitted, and the front and rear portions 106a, 106b could be considered to be the stoppers. It is to be noted that in some embodiments, the lower recess 110 could be omitted, and instead, the inner part 100 could define a laterally extending aperture configured to receive a laterally extending pivot.

The inner part 100 is configured to connect to a fixed structure of the vehicle 30. The fixed structure may be the frame of the vehicle 30 or another structure fixed on the frame of the vehicle 30. In this embodiment, the mounting portion 104 is configured to connect to the axle housing of the driving shaft 34. The mounting portion 104 defines a central aperture 105 that is configured to receive the axle housing therein. Indeed, since the axle housing conventionally has a cylindrical or a frustoconical shape, the central aperture 105 surrounds at least partially the axle housing. It is understood that the central aperture 105 is generally complementary to a shape of the axle housing and/or the other fixed structure to which the upper frame member 62 is configured to connected to. In this embodiment, since both the central aperture 105 and the axle housing are circular, the inner part 100 can be mounted to the axle housing in a plurality of positions. The mounting portion 104 is configured to connect to the axle housing or the fixed structure of the vehicle 30, either removably (e.g., using fasteners) or permanently (e.g., via welds). In some embodiments, the upper frame member 62 is part of the vehicle 30.

The outer part 102 extends generally longitudinally, and is configured to connect to the front and rear portions 106a, 106b. When the inner and outer parts 100, 102 are connected, the outer part 102 also partially defines the cavity 108. Thus, the upper frame member 62, when the inner and outer parts 100, 102 are connected to one another, is configured to generally surround the drive wheel assembly 50. In some embodiments, the outer part 102 could be omitted.

### Pivot Assembly

The pivot assembly 64 is removably connected to a bottom of the inner part 100, specifically at the lower recess 110. In some embodiments, the pivot assembly 64 could be configured to connect to the outer part 102, or to the lower frame member 66 instead. In some embodiments, the pivot assembly 64 could be integrated to one of the upper and lower frame members 62, 66.

The pivot assembly 64, as mentioned above, defines the pivot axis 65, which is transversal to the track system 42. It is to be noted that the frame assembly 100 is designed such that the pivot axis 65 is disposed vertically below the driving axis 52.

The pivot assembly 64 has a pivot housing 120 and a pivot pin 122. The pivot housing 120 is sized to be received in the lower recess 110, and defines a laterally extending aperture configured to receive the pivot pin 122 therein. The pivot pin 122 is configured to extend laterally when the pivot assembly 64 is connected to the upper frame member 62. In this embodiment, the pivot pin 122 is configured to be received in pin apertures 136 defined in the lower frame member 66. In some embodiments, the pivot pin 122 is part of the lower frame member 66 and the pin aperture 136 is defined in the upper frame member 62. In some embodiments, the pivot pin 122 is part of the pivot assembly 64, and is received in a pin aperture that is defined in the upper frame member 62 and in a pin aperture defined in the lower frame member 66.

Due to the pivot assembly 64, when the vehicle 30 travels on a slopped terrain, the lower frame member 66 of the track system 42 can pitch positively or negatively about the pivot axis 65 to conform to the contour of the terrain.

Additionally, as will be described in greater detail, the initial resting position of the pivot axis 65 (i.e., when the track system 42 is resting on a flat surface) can be selectively moved vertically and longitudinally by adjusting the position of the upper frame member 62 relative to the axle housing.

### Lower Frame Member

The lower frame member 66, which is disposed vertically below the upper frame member 62, extends in the longitudinal direction. The lower frame member 66 has a central portion 130, a front portion 132a extending longitudinally forward from the central portion 130 and a rear portion 132b extending longitudinally rearward from the central portion 130. In some embodiments, it is contemplated that the lower frame member 66 could be made of two or more distinct members connected to one another. The lower frame member 66 is typically made of a rigid material, such as aluminum or steel.

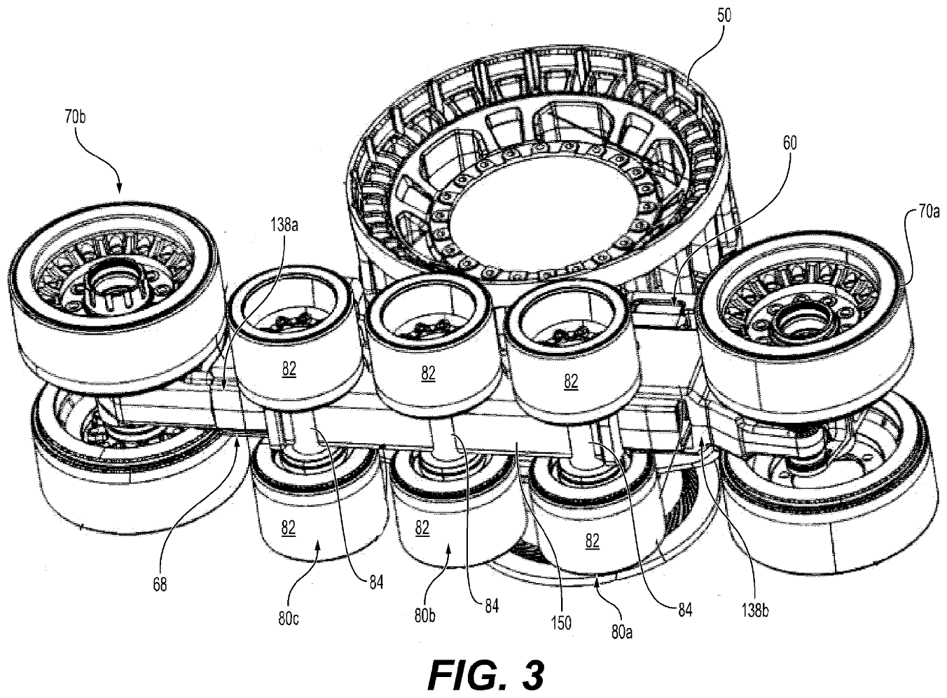

The central portion 130 defines an aperture 134 configured to receive a bottom part of the drive wheel assembly 50 (i.e., the aperture 134 provides clearance). In some embodiments, the aperture 134 may be omitted. The central portion 130 has two tabs that each define the pin aperture 136 configured to receive the pivot pin 122 therein. As best seen in FIG. 3, the front portion 132a defines a front recess 138a, and the rear portion 132b defines a rear recesses 138b. The front and rear recesses 138a, 138b are defined in the vertical direction, from a bottom surface of the lower frame member 66 upwardly therefrom. The recesses 138a, 138b are configured to receive portions of the suspended undercarriage assembly 68, as will be further described below. Additionally, the leading portion 132a is configured to rotationally connect to the front idler wheel assembly 70a, and the trailing portion 132b is configured to rotationally connect to rear idler wheel assembly 70b.

### Undercarriage Assembly

As mentioned above, the undercarriage assembly 68 is connected to the lower frame member 66 via the leading and trailing recesses 138a, 138b, such that it can be referred to as a suspended undercarriage assembly 68. In this embodiment, the undercarriage assembly 68 is similar to the undercarriage assembly described in PCT Patent Application No. PCT/IB2021/050507, titled “Suspended Undercarriage Assembly for a Track System”, published under No. WO2021149008A1, which is incorporated herein by reference in its entirety. Other configurations are contemplated as well. Thus, the undercarriage assembly 68 will only briefly be described.

As best seen in FIGS. 2 to 4, the undercarriage assembly 68 includes a beam 150 and leading and trailing bushings 151a, 151b. In some embodiments, the support wheel assemblies 80a, 80b, 80c could be considered as being part of the undercarriage assembly 68.

The beam 150 has a front portion 152a and a rear portion 152b. At the front portion 152a, the beam 150 has a leading pin 154a. Similarly, at the rear portion 152b, the beam 150 has a trailing pin 154b. The beam 150 further defines an undercarriage axis 155 that extends through the front and rear pins 154a, 154b.

The front and rear bushings 151a, 151b are resiliently deformable, and are connected to, respectively, the front and rear pins 154a, 154b. Additionally, the front and rear bushings 151a, 151b are received in the front and rear recesses 138a, 138b. The front and rear bushings 151a, 151b are sized to be received in the front and rear recesses 138a, 138b by an interference fit. The front and rear bushings 151a, 151b enable movement of the beam 150 relative to the frame assembly 60 in the vertical and lateral directions. Additionally, in response to the beam 150 moving away from an initial position, the leading and trailing bushings 151a, 151b, due to their resilient nature, bias the beam 150 towards its initial position.

When track system 42 travels over a laterally slopped terrain, such as a crowned road, the support wheel assemblies 80a, 80b, 80c and the beam 150 pivot about the undercarriage axis 155. In other words, the support wheel assemblies 80 are free to, to some extent, capable of roll motion relative to the frame assembly 60. When the support wheel assemblies 80a, 80b, 80c and the beam 150 pivot about the undercarriage axis 155, the front and rear pins 154a, 154b rotate pivot about the undercarriage axis 155, thereby causing the bushings 151a, 151b of the front and rear bushing 151a, 151b to resiliently deform. Specifically, the bushings 151a, 151b are resiliently deformed circumferentially about the undercarriage axis 155. In some embodiments, the front and rear bushings 151a, 151b are structured to permit movement of the beam 151 in a predetermined range. The front and rear bushings 151a, 151b also resiliently bias the beam 150 towards an initial position.

Furthermore, when the track system 42 travels over a bump or into a hole, the support wheel assemblies 80 and the beam 150 can move vertically, and the front and rear pins 154a, 154b also move vertically and cause the front and rear bushings 151a, 151b to resiliently deform in the vertical direction about the undercarriage axis 155. In other words, the front and rear bushings 151a, 151b are resiliently deformed radially about the undercarriage axis 155. The vertical displacement of the support wheel assemblies 80 and the beam 150 is enabled by the deformation of the front and rear bushings 151a, 151b which absorb at least a portion of the impact induced by the bump or hole over which the track system 42 travels. The front and rear bushings 151a, 151b thus provide some damping of the undercarriage assembly 150 relative to the frame assembly 60.

### Endless Track

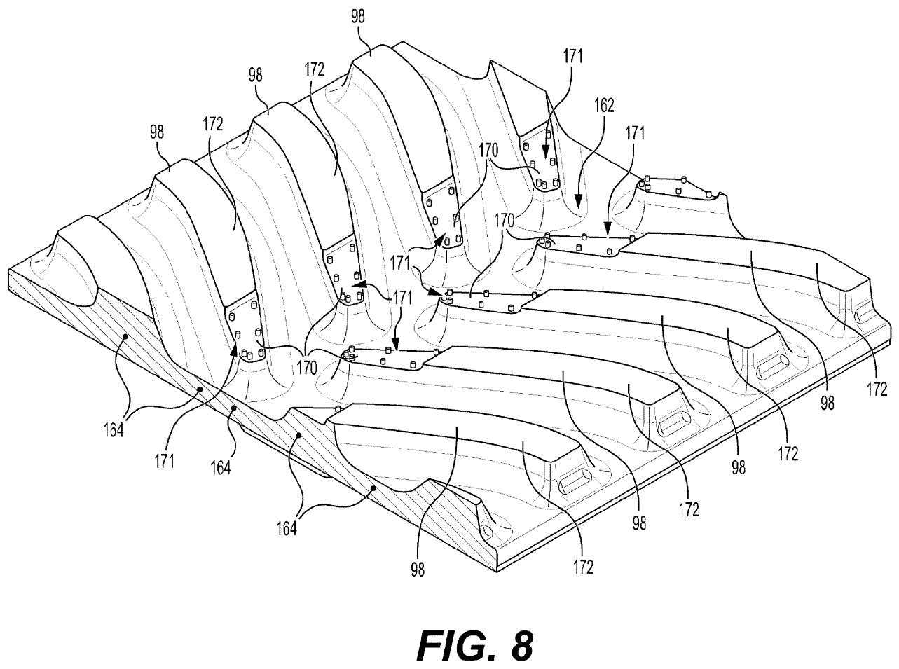

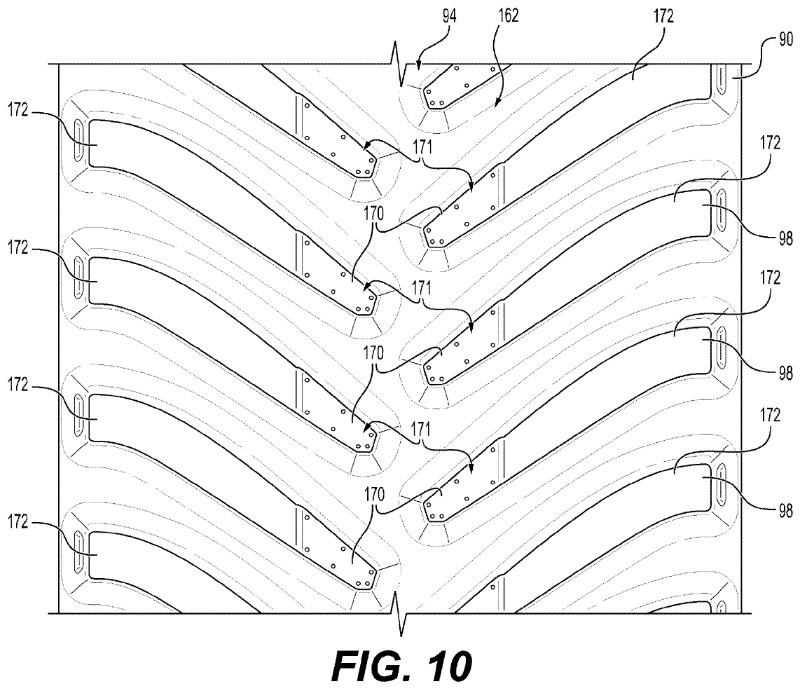

With reference to FIGS. 8 to 11, the endless track 90 will now be described in greater detail. The endless track 90 is a polymeric endless track. It is contemplated that within the scope of the present technology, the endless track 90 may metallic components. The endless track 90 has, as mentioned above, an inner side 92 and an outer side 94.

The inner side 92 is configured to engage the drive wheel assembly 50, the idler wheel assemblies 70, and the support wheel assemblies 80. The endless track 90 has, on the inner side 92, the driving lugs 96 which are disposed centrally across a width of a body of the endless track 90. The driving lugs 96 are longitudinally spaced from one another. On either lateral side thereof, the endless track 90 has road-wheel paths 160a, 160b. The road-wheel path 160a, 160b is where the wheels 72, 82 of the idler and support wheel assemblies 70, 80 roll while the track system 42 is in operation.

The outer side 94 of the endless track 180 has the traction lugs 98 which form a tread 162. The tread 162 can vary from one embodiment to another according to the type of vehicle on which the track system 42 is mounted and/or according to the type of ground surface on which the vehicle 30 is destined to travel.

In one embodiment, the endless track 90 measures 30 inches in width and measures 1.25 inches in thickness. Furthermore, the endless track 90 has reinforcing cables 164 that are three steel ply embedded therein and that have a diameter of 0.17 inches. The driving lugs 96 have a drive lug pitch of 6 inches. Additionally, the traction lugs 98 have a thickness of about 1.7 inches. Other configurations and other dimensions for the endless track are contemplated as well.

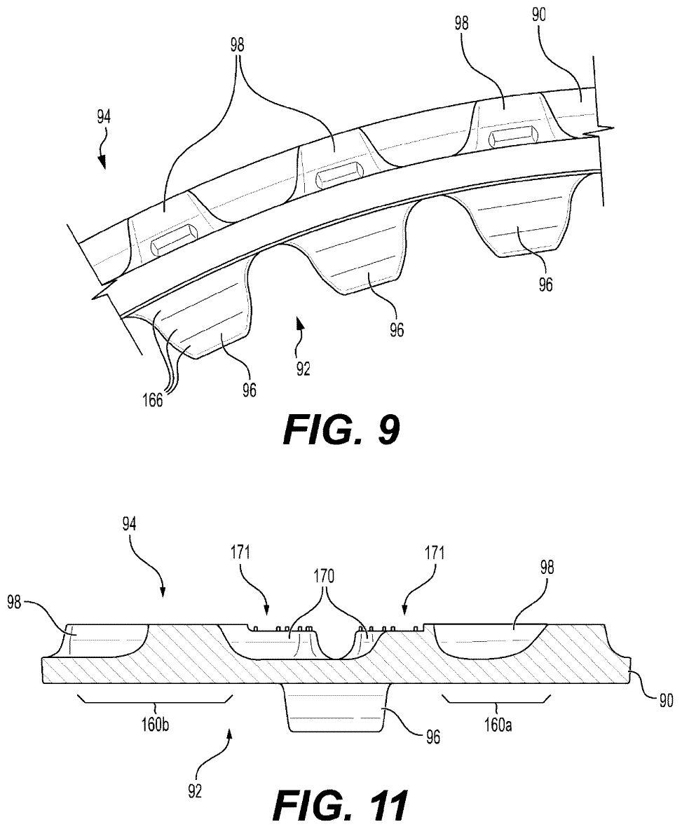

Referring to the FIGS. 9 and 11, the driving lugs 96 are optimized for high torque application, (i.e., where the vehicle 30 is configured to apply a high torque to the drive wheel assembly 50, which in turn, is configured to apply a high load on the driving lugs 96 to move the endless track 90. The driving lugs 96 have a profile composed of multiple surfaces 166 and are sized for high torque application. To further assist in sustaining the high loads that the driving lugs 96 are subjected to, the drive lugs 96 are made at least partially of hard (stiff) rubber compound.

The traction lugs 98 have an inner portion 170 and an outer portion 172, the inner and outer portions 170, 172 extending along a length of the traction lug 98. As best seen in FIG. 11, for a given traction lug 98, in the lateral direction, the outer portion 172 extends from an edge of the endless track 90 toward a corresponding lateral side of a corresponding lateral lug 98. In some embodiments, the outer portion 172 is partially spaced from the corresponding lateral side of the corresponding lateral lug 98. On the other hand, for the given traction lug 98, in the lateral direction, the inner portion 172 extends from near the driving lug 96 toward a center of the width of the endless track 90. In some embodiments, the inner potion 172 extends from the corresponding lateral side of the corresponding lateral lug 98. In other embodiments, the inner portion 172 extends past the corresponding lateral side of the corresponding lateral lug 98. In other embodiments, the inner portion 172 extends from beyond the corresponding lateral side of the corresponding lateral lug 98. In some embodiments, the inner portion 172 reaches the center of the width of the endless track 90. In other embodiments, the inner portion 172 is spaced from the center of the width of the endless track 90. It is to be noted that the given traction lug 98 and the corresponding driving lug 96 are not necessarily longitudinally aligned. In some embodiments, the outer portion 172 extends below the road wheel paths 160a, 160b.

The traction lugs 98 are oriented to optimize evacuation of matter therefrom, for enhanced ground penetration, and for enhanced traction. For example, the shape and orientation of the traction lugs 98 relative to the longitudinal direction of the endless track 180 allow for a better evacuation of mud (i.e., provide a pathway for the mud to escape through the side thereof). An aggressive angle and a thinner traction lug 98 nose portion allow for a better ground penetration. Indeed, the inner portion 170 defines a recess 171. A base of the traction lugs 98 is also sized with a large radius to preventing cracking. Additionally, the outer portion 172 of the traction lugs 98 being at least partially perpendicular to a longitudinal direction of the endless track 98 can enhance traction.

Additionally, the volume of elastomeric material (e.g., rubber) under the road wheel-path 160a, 160b (i.e., at least part of the outer portion 172 of the traction lugs 98) is optimized (i.e., maximized) to enhance the durability of the endless track 90 while the volume of elastomeric material (e.g., rubber) under the driving lugs 96 (at least part of the inner portion 170 of the traction lugs 98) is optimized (i.e., minimized) to enhance the crack resistance of the endless track 180. Thus, a cross-sectional area of the traction lug 98 at the inner portion 170, taken along plane perpendicular to the inner portion 170 is smaller than a cross-sectional area of the traction lug 98 at the outer portion 172, taken along a plane perpendicular to the outer portion 172.

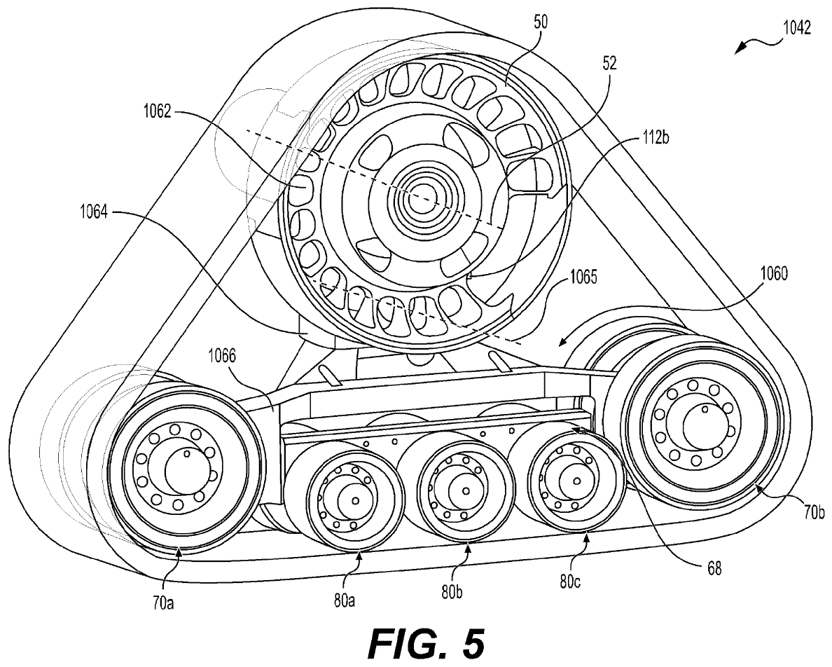

Referring to FIGS. 5 and 6, another embodiment of the track system 42, namely track system 1042, will now be described. Features of the track system 1042 that are similar to the features the track system 42 have been labeled with the same reference numerals, and will not be re-described in detail herewith.

The track system 1042 includes the drive wheel assembly 50, a frame assembly 1060, the front and rear idler wheel assemblies 70, the support wheel assemblies 80 and the endless track 90.

In this embodiment, the frame assembly 1060 differs from the frame assembly 60. The frame assembly 1060 is a multi-member frame assembly that includes an upper frame member 1062, a pivot assembly 1064, and a lower frame member 1066. The pivot assembly 1064 is disposed between the upper and lower frame members 1062, 1066 and allow a pivotal movement therebetween about a pivot axis 1065. The pivot axis 1065 is generally transversal to a longitudinal center plane of the vehicle 30.

Broadly, the frame assembly 1060 is configured to be manufactured with less material than the frame assembly 60. Specifically, the upper frame member 1062 has a mounting portion 1104 with front and rear stoppers 1112a, 1112b disposed on either longitudinal side thereof. However, the upper frame member 1062 is not configured to surround the drive wheel assembly 50. The upper frame member 1062 is disposed laterally inwardly from the drive wheel assembly 50, which can assist in reducing mud accumulation, and reduce mass of the track system 1042.

Similarly, to the upper frame member 62, the upper frame member 1062 is configured to be removably connected to the axle housing 1035 or another fixed structure of the vehicle 30. Thus, the mounting portion 1104 interconnects the frame assembly 1062 to the axle housing 1035 of the vehicle 30. Since the axle housing 1035 conventionally has a cylindrical or frusto-conical shape, the mounting portion 1104 defines a central aperture 1105 configured to surround, at least partially, the axle housing 1035. It is understood that the central aperture 1105 is generally complementary to the shape of the axle housing 1035 and/or the other fixed structure to which the upper frame member 1062 is connected to. The mounting portion 1104 is configured to be removably connected to the axle housing 1035 or to the other fixed structure, using fasteners.

Similarly to the upper frame member 62, and as will be described below, the upper frame member 1062 can be installed in a plurality of different orientations about the driving axis 52 for varying the position of the pivot axis 1065 (in longitudinal and vertical directions).

### Pivot Assembly

As mentioned above, the pivot assembly 1064 enables pivotal movement between the upper and lower frame members 1062, 1066 about the pivot axis 1065. In this embodiment, the pivot axis 1065 is vertically spaced from the driving axis 52.

The pivot assembly 1064, which includes a pivot housing 1120 and a pivot pin 1122, is a stand-alone assembly that is removably connected to the upper and lower frame members 1162, 1166. The pivot housing 1120 defines a cavity 1121, and is configured to connect to a top of the lower frame member 1166. The cavity 1121 is configured to receive part of the upper frame member 1162 as well as the pin pivot 1122 such that the pin pivot 1122 extends generally laterally when the pivot pin 1122 is connected to the pin housing 1120. Other configurations are contemplated as well. For example, the pivot assembly 1164 could be configured to connect to a bottom of the upper frame member 1162. In some embodiments, the pivot assembly 1164 could be integrated to one of the upper and lower frame members 1162, 1166. The lower frame member 1166 being generally similar to the lower frame member 66 will not be described herewith.

### Different Orientations

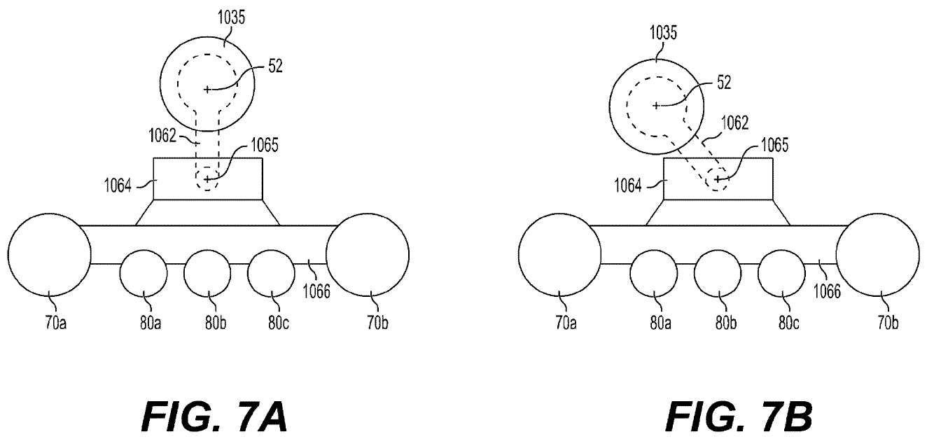

Referring to FIGS. 7A and 7B, and with reference to the track system 1042, the upper frame member 1062 being connected to the fixed structure of the vehicle, the axle housing 1035 in the illustrated embodiment, in different orientations will now be described. It is understood that the upper frame member 62 could be used similarly. In the illustrated non-limiting example, since the axle housing 1035 is circular, and thus defines a circular fastening pattern, and since the central aperture 1104 defines a circular shape that is complementary to the axle housing 1035, the upper frame member 1062 can be connected to the axle housing 1035 in a plurality of angularly spaced positions about the driving axis 52. By doing so, as shown in FIG. 7B, the position of the pivot axis 1065 is moved longitudinally and vertically. Specifically, depending on the initial position of the pivot axis 1065, the position of the pivot axis 1065 can be moved longitudinally forward or longitudinally rearward and can move vertically upward or downward depending on whether the upper frame member 1062 whether the upper frame member 1062 is rotated in a clockwise direction or in a counterclockwise direction. For example, the upper frame member 1062 is in an initial position in FIG. 7A. It is contemplated that the initial position of the upper frame member 1062 could vary from one embodiment to another. In FIG. 7B, the position of the upper frame member 1062 has been adjusted such that it has now been rotated by about 15 degrees about the driving axis 52. In this figure, the pivot axis 1065 has moved rearward and upward with respect to its initial position (i.e., the pivot axis 1065 is offset from its initial position). The movement of the pivot axis 1065 can assist in adapting the track system 1042 for various tasks, depending on what specific characteristic of the track system is desired. For example, this may be useful to accommodate the track system 1042 from one vehicle to another, to modify a track system performance such as floatability and/or traction by adjusting a contact patch of the track system 1042, and/or to change clearance between the vehicle 30 and the ground. In some instances, the pivot axis 1065 can be moved to modulate durability and/or ride quality of the track system 1042.

As one may notice, while the track system 42 is in a given configuration (in which the upper frame member is in a given position) that is offset from the initial position, the lower frame member 1066 can still pivot about the upper frame member 1062.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A track system for a vehicle, the track system comprising: a drive wheel assembly operatively connectable to a shaft of the vehicle, the drive wheel assembly being rotatable about a first pivot axis; a frame assembly including: a first frame member configured to removably connect to the vehicle, a second frame member pivotally connected to the first frame member about a second pivot axis, the second pivot axis being vertically spaced from the first pivot axis; an undercarriage assembly comprising: a beam having a connecting pin; at least one resilient bushing having a first surface fixedly connected to the connecting pin, and a second surface fixedly connected to the second frame member; and at least one support wheel assembly connected to the beam; an endless track drivingly engaged to the drive wheel assembly.

2. The track system of claim 1, wherein the first frame member is configured to connect to an axle housing of the vehicle.

3. The track system of claim 1, wherein the second frame member is at least partially below the first frame member.

4. The track system of claim 1, wherein the frame assembly is disposed at least partially laterally inwardly from the drive wheel.

5. The track system of claim 1, wherein the first frame member is configured to connect to the vehicle in a plurality of positions.

6. The track system of claim 5, wherein a first position of the plurality of positions is angularly offset from a second position of the plurality of position.

7. The track system of claim 6, wherein: when the first frame member is in the first position, the second pivot axis is in a first axis position; when the first frame member is in the second position, the second pivot axis is in a second axis position; and the first axis position is offset from the second axis position in at least one of: a longitudinal direction and a vertical direction.

8. The track system of claim 1, wherein the first frame member has: a first portion disposed on a first longitudinal side of the drive wheel assembly; a second portion disposed on a second longitudinal side of the drive wheel assembly;
and the first and second portions of the first frame member at least partially surround the drive wheel assembly.

9. The track system of claim 1, wherein the frame assembly further includes a pivot assembly having a pin defining the pivot axis, and the second frame member is pivotally connected about the second pivot axis to the first frame member by the pivot assembly.

10. The track system of claim 1, wherein the first frame member has stoppers to limit pivotal moment of the first and second frame members.

11. An endless track for a track system, the endless track comprising: a track body having: an inner surface engageable by at least one wheel assembly of the track system; an outer surface engageable to a ground surface; and a plurality of traction lugs projecting from the outer surface, the traction lugs being spaced along a length of the track body, and a given traction lug of the plurality of traction lugs: having an inner portion and an outer portion, the inner and outer portions extending along a length of the given traction lug, and the outer portion being closer to an edge of the track body than the inner portion; and the inner portion having an inner volume, and the outer portion having an outer volume, the outer volume being greater than the inner volume.

12. The endless track of claim 11, wherein the inner portion defines a recess.

13. The endless track of claim 11, wherein a given traction lug of the plurality of traction lugs has: a first cross-sectional area taken across a plane perpendicular to the inner portion; a second cross-sectional area taken across a plane perpendicular to the outer portion; and the first cross-sectional area is less than the second cross-sectional area.

14. The endless track of claim 11, wherein the inner portion defines an aggressive angle.

15. The endless track of claim 11, wherein the given traction lug has a large radius.

16. The endless track of claim 11, wherein the outer portion extends from an inner side of a wheel path of the track body to the edge of the track body.

17. The endless track of claim 11, wherein the given traction lug at least substantially perpendicular to a longitudinal plane of the track body.

18. The endless track of claim 17, wherein the outer portion of the given traction lug is at least partially perpendicular to the longitudinal plane of the track body.

19. The endless track of claim 11, wherein the given traction lug is partially arcuate.

20. A track system for a vehicle, the track system comprising: a multi-member frame assembly including: a primary frame member defining a mounting portion, and a secondary frame member below the primary frame member and pivotable relative to the primary frame about a pivot axis; a drive wheel operatively connected to an axle of the vehicle; a leading idler wheel assembly at least indirectly connected to the multi-member frame assembly; a trailing idler wheel assembly at least indirectly connected to the multi-member frame assembly; a suspended undercarriage assembly resiliently connectable to the secondary frame member; and an endless track wrapped around the multi-member frame assembly, the leading and trailing idler wheel assemblies, and the suspended undercarriage assembly, wherein the mounting portion is removably connectable to a fixed structure of the vehicle.

21.-26. (canceled)
